(19) United States
(12) Patent Application Publication
(10) Pub. No.: US 2023/0148485 A1
(43) Pub. Date: May 18, 2023

(54) PROGRESSIVE PLANT AND FISH PRODUCTION METHOD AND APPARATUS

(71) Applicant: Richard Hook, Lexington, SC (US)

(72) Inventor: Richard Hook, Lexington, SC (US)

(21) Appl. No.: 17/989,545

(22) Filed: Nov. 17, 2022

Related U.S. Application Data
(60) Provisional application No. 63/280,208, filed on Nov. 17, 2021.
(60) Provisional application No. 63/280,208, filed on Nov. 17, 2021.

(51) Int. Cl. A01G 9/029

(52) U.S. Cl. CPC A01G 9/0295; A01G 2009/003

(57) ABSTRACT

A method of growing fish and marijuana in a single body of water, includes planting seeds; growing the seeds in a nursery until the plants are 8 inches tall; potting the plants into individual pots; placing the pots with the plants into a float; placing the float into a first bay in a tank with 58 bays and fish in corresponding baskets to be situated under the float with the potted plants; incubating the plants in the first bay and the fish in the corresponding fish basket for 7 days; moving the float and corresponding fish basket into the second bay; adding a second float with another round of potted plants and a second corresponding fish basket into the first bay; progressing the floats and corresponding fish baskets forward to the next bay and adding subsequent floats and corresponding fish baskets into the first bay each 7 days; after 7 days in the 58th bay, harvesting the fish; trimming the plants; moving the plants to a first bay of a flowering stage tank.

### CROSS REFERENCE TO RELATED APPLICATION

Pursuant to 35 U.S.C. § 120, this application is a continuation-in-part of and claims priority to U.S. Provisional Pat. Application No. 63/280,208, filed on Nov. 17, 2021, the entire contents of each of which are incorporated herein by this reference.

### FIELD OF THE INVENTION

This invention relates to a method and apparatus for simultaneously growing plants and farming fish. More specifically, it relates to a method and apparatus that recycles and utilizes nutrients from fish farming to enhance plant growth.

### BACKGROUND

The current static indoor marijuana growing process involves the growing of seedlings into full plants under artificial lighting, supplying water/nutrients, with control of the temperature and humidity. A marijuana plant has two growth stages: 75 days vegetive and 75 days flowering. Growers may provide a different light source for each stage or provide the same light source for both stages. The time of light exposure is typically 18 hours for the vegetive stage and 12 hours for the flowering stage. The distance of the light source from the foliage can be at a fixed height or be adjusted as the plant grows. The water/nutrients for each stage can be customized or be the same for both stages. In the vegetive stage to minimize grow area plants can be closely packed. In the flowering stage, typically plants are spaced to provide more light exposure to their foliage.

Some vegetable and plant growth facilities utilize hydroponics. Often facilities grow fish in conjunction with plants. In this process called aquaponics, the fish provide the plants fertilizer from their excrements. The typical aquaponic facility has segregated fish tanks with pumps flowing the water to the separate marijuana growth equipment. The growth cycle of a fish such as tilapia is 240 days.

The problem with aquaponics is that separate fish tanks are needed for different ages of fish. And an elaborate array of tanks, piping, pumps, filters, and electricity is needed to move the water from the fish grow tanks to the vegetable and plant grow area. Accordingly, there exists an unresolved need for a compact and efficient aquaponics growth facility.

### SUMMARY OF THE INVENTION

The unresolved need stated above is now met by a novel and non-obvious invention disclosed and claimed herein. Implementation of Progressive Plant Production will achieve continuous daily uninterrupted plant growing and continuous 8 hours per day of employment. This process will end the current stop and start labor intensive, then no labor required static plant growing process. People employed in this facility will have a stable 5 day a week job with their weekends off. A job they can depend on. Progressive plant production will result in consistent production of a high-quality product. Progressive plant production can be implemented into the growth process of vegetables and flowering plants and as marijuana.

In one exemplary embodiment, seeds will be planted each day Monday through Friday. Seeds will grow.

### DESCRIPTION OF THE DRAWINGS

For a fuller understanding of the invention, reference should be made to the following detailed description, taken in connection with the accompanying drawings, in which:

FIG. 1 illustrates an integrate marijuana/fish growing apparatus.

FIG. 2 is a top view of the growing apparatus during the vegetive stage of the growing method.

FIG. 3 is a side view of the growing apparatus during the vegetive stage.

FIG. 4 is a side view of the flowering stage two-level tank.

FIG. 5 is a side view of the vegetive stage water tank.

FIG. 6 illustrates the method of spraying hydrogen peroxide into the soil of the potted plants during the vegetive stage.

FIG. 7 illustrates the method of spraying the foliage of the plants during the vegetive stage.

FIG. 8 illustrates the lighting configuration to control the amount of light applied to the plants.

FIG. 9 is a side view of the UV chamber.

FIG. 10 illustrates a plant in the microwave chamber.

FIG. 11 is a top perspective view of the flowering stage tank.

FIG. 12 illustrates the method of spraying hydrogen peroxide into the soil of the potted plants during the flowering stage.

FIG. 13 illustrates the method of spraying the foliage of the plants during the flowering stage.

FIG. 14 illustrates the mechanical components that are used to maintain the preferred environmental characteristics of both the vegetive tank and the flowering tank.

FIG. 15 illustrates the recycling process to use the fish feces for fertilizer whiel conserving water.

FIG. 16 illustrates a tin that may be used to grow plants without a tank.

FIG. 17 illustrates the support structure for the tin.

FIG. 18 illustrates a watering structure for the tins.

FIG. 19 illustrates a drip ring with water reservoir.

FIG. 20 illustrates a vegetive nutrient feed system.

FIG. 21 illustrates the loading and removal of plantings from the vegetive stage.

FIG. 22 illustrates the six-ring pot holder with connector loops.

FIG. 23 illustrates a flowering nutrient feed system.

FIG. 24 illustrates a flowering drip system.

FIG. 25 illustrates the loading and removal of plantings from the flowering stage.

FIG. 26 illustrates versions of ring pot holders.

FIG. 27 illustrates a trellis assembly for the flowering stage.

FIG. 28 is a side view of a building structure for three level progressive plant growing.

FIG. 29 is a side view of a progressive plant building structure utilizing pallet racks.

### DETAILED DESCRIPTION OF THE PREFERRED EMBODIMENT

In the following detailed description of the preferred embodiment, reference is made to the accompanying drawings, which form a part hereof, and within which specific embodiments are shown by way of illustration by which the invention may be practiced. It is to be understood that other embodiments may be utilized and structural changes may be made without departing from the scope of the invention.

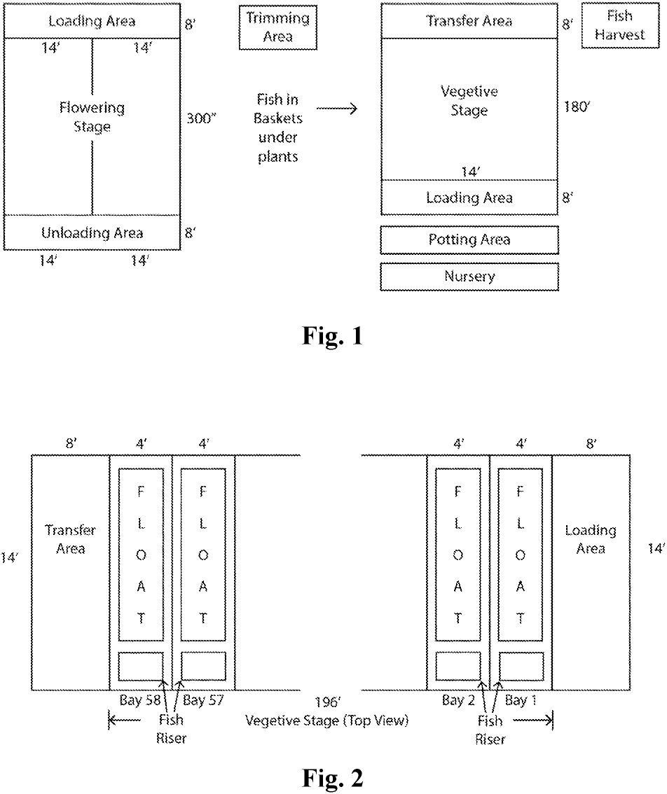

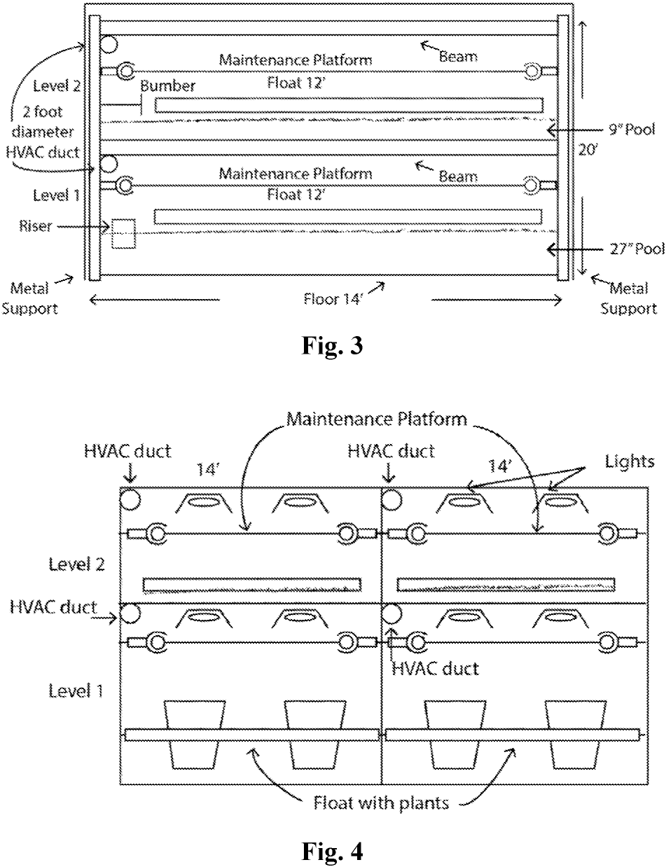

Referring to FIGS. 1 through 5, various views of the growing apparatus are shown. The first phase is the planting phase. Seeds will be planted every weekday, Monday through Friday, but not on weekend days. Seeds will be grown in the nursery until a height of about 8 inches. Then, seedlings will be potted and begin the vegetive cycle.

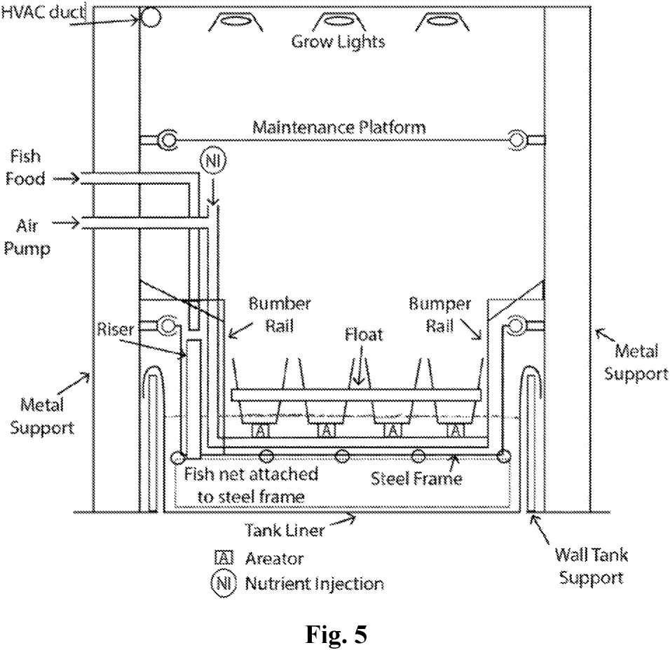

The vegetive cycle will begin with a nursery. The nursery will grow marijuana from seeds until the seedling is 8 inches tall, typically 4 weeks. For Level 1, to provide a tank to grow fish, a 27″ deep tank will be constructed and contained by the metal structure of the vegetive cycle. This tank will measure 196 feet × 14 feet. For Level 2, to provide water containment, a pool depth of 9″ will be constructed measuring 196 feet × 14 feet. The superstructure of the vegetive stage will be covered with 4′ × 8′ insulating sheets of R-Max type material and then will be enveloped in a tarp made of reinforced polypropylene or HODE. For both Levels 1 and 2 a Styrofoam raft measuring 4 feet by 12 feet will float progressively forward each day under the grow lights of the vegetive cycle. To progress the fish under the rafts of Level 1 of the vegetive cycle a cage will be constructed as depicted in FIG. 5. Both ends of the vegetive state will be enclosed by a drop down “garage door” (not depicted in FIG. 5).

The fish will be contained in fishnet “baskets” which will be attached to a metal frame below the marijuana plants in the vegetive cycle of Level 1. There will be 35 four foot wide by 14 feet long fish baskets each linked together with a 1-foot spacer. The frames/baskets will be progressed forward along a rail. All fish baskets will be static for 7 days. On day 8 all fish baskets will be progressed five feet with the emerging basket being harvested.

At the end of each fish basket will be a 1 foot by 4-foot riser. The purpose of the riser is: a) Provide a surfacing area for the fish, and b) Feeding area. A maintenance platform will be mounted on rollers allowing a person to travel beneath grow lamps when turned off to render maintenance upon them.

Located between the growing floats and the progressing fish baskets, attached to the bottom of the rails, is a static pipe to which aerators are attached. The purpose of the aerators is to oxygenate the water for the benefit of the plants and fish. A port is on the pipe, NI, for the inj ection of Hydrogen Peroxide (H20 2) which is beneficial for the plants with no harm to the fish.

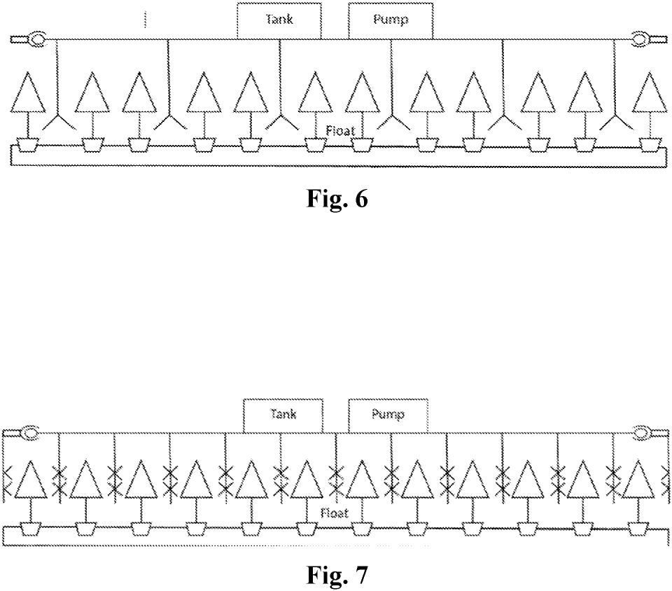

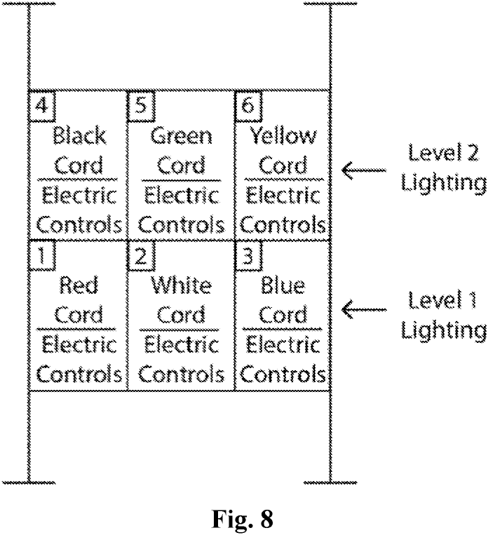

The vegetive cycle will have a maintenance platform which will traverse the length of the cycle and be structural to carry an employee. The platform will have a dual spray attachment for spraying either hydrogen peroxide on the surface of the soil in each to penetrate the roots, FIG. 6; or spray a foliage spray, FIG. 7. Both, on the same structure.

Lighting will be vegetive stage specific. Lights will be attached to the ceiling of Level 1 and ceiling of Level 2. The light exposure will be 18 hours on and 6 hours off. As before the lights of each level will be mounted to the ceilings the light exposure will be 12 hours on and 12 hours off. The procedure for mounting electric and rope control of the light will be the same as the vegetive stage.

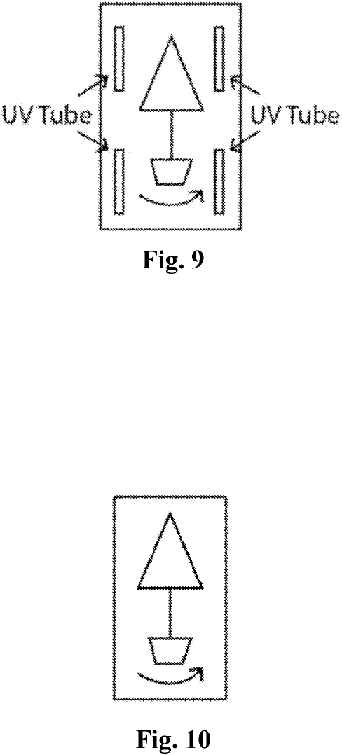

After each plant has been trimmed, each plant will be separately placed in the UV-C chamber and rotated for one minute, FIG. 9. Then each plant will be placed separately in a microwave chamber and rotated for one minute, FIG. 10.

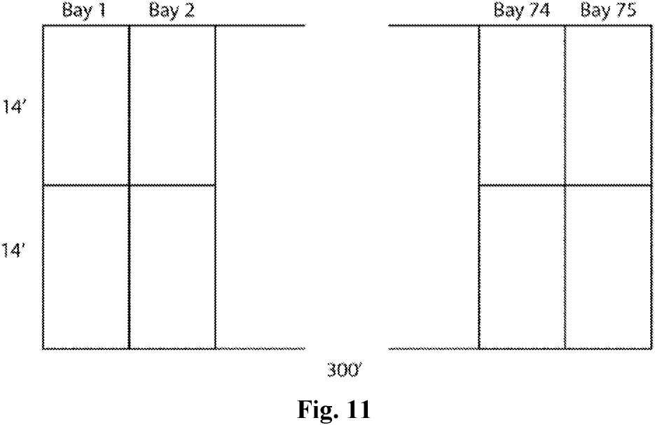

The flowering stage of progressive plant production will have the following differences: Spacing of the plants, Light source, Time of light exposure. Being the plants will be spaced apart in the flowering stage, the area of the flowering stage will be doubled. The result will be 2 parallel 14 feet by 300-foot grow bays. Each bay will expose a day’s plantings to light, FIG. 11.

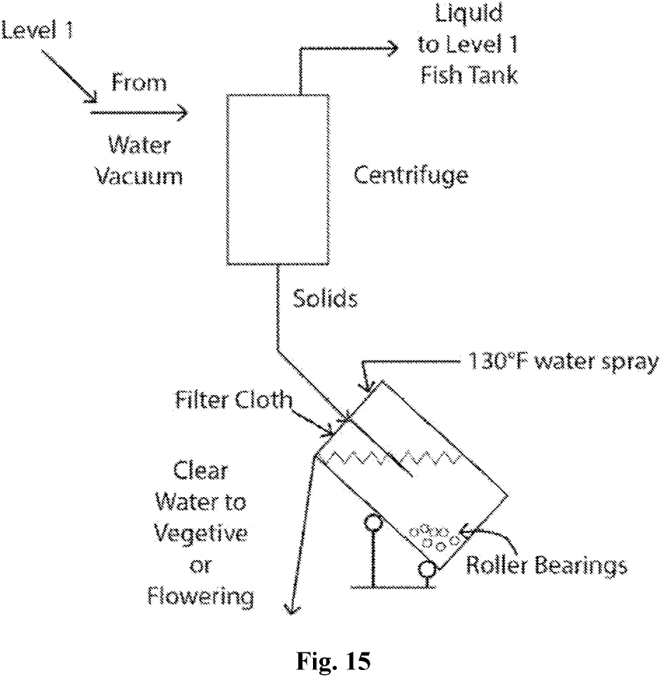

The plant flow from Level 1 of the vegetive stage will flow to Level 1 of the flowering stage. Level 2 of the vegetive stage will flow to Level 2 of the flowering stage, FIG. 15. A 9-inch pool of water will be established for levels 1 and 2. Plants will progressively float on 4′×12′ Styrofoam floats thru the Flowering cycle. Both ends of the flowering sage will be enclosed by a drop down “garage door” (not depicted in FIG. 11).

In the flowering cycle for plant stability, a steel-spined two-tier trellis will be attached to each float.

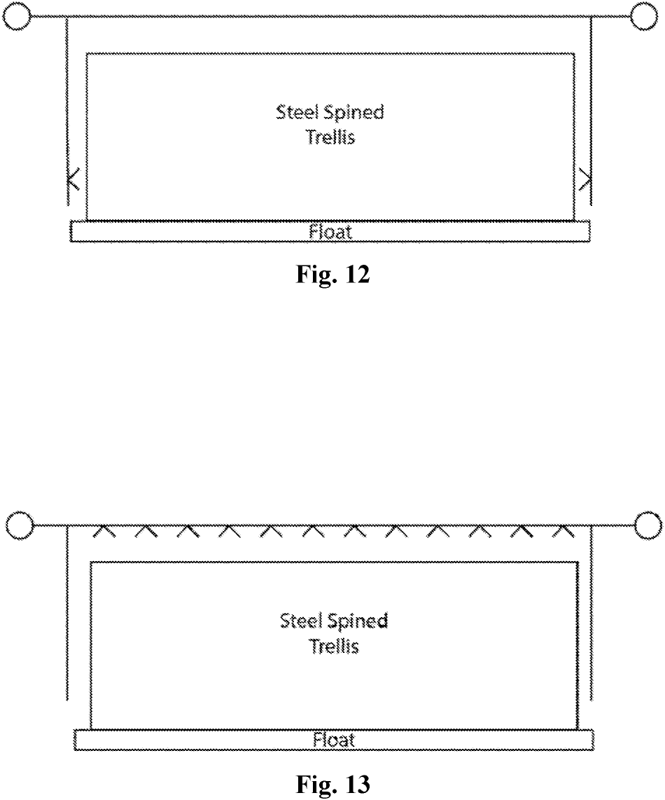

Each bay of the flowering stage will have a maintenance platform. This platform will have a dual spray attachment for spraying either hydrogen peroxide, FIG. 12, or foliage spray, FIG. 13.

For the vegetive stage there will be two heat/AC units working in tandem to maintain temperature and humidity. In the flowering stage each of the two grow areas will have two heat/AC units for temperature and humidity control. All units will have germicide lights to kill spores in the air.

In progressive growth of marijuana/fish the waste heat discharged from the engine’s radiator will be used to heat the water for the fish and plants. The waste heat discharged from the exhaust gas will be utilized to heat air circulating the plants. Utilization of these heat sources will achieve a thermal efficiency of 80 to 90%.

To transfer heat from the engine’s cooling water, a closed loop water system using water from the flowering stage along with an intermediary heat exchanger (Heat Exchanger #1) will be necessary. Exposure of the vegetive/fish water to a temperature greater than 165° F. (the temperature of the generator’s engine water is 240° F.) will kill beneficial bacteria in the vegetive/fish water which is necessary for nitrification of fish waste. Being the flowering water is in a closed loop, exposure to the high engine temperature (724° F.) will kill bacteria in the water.

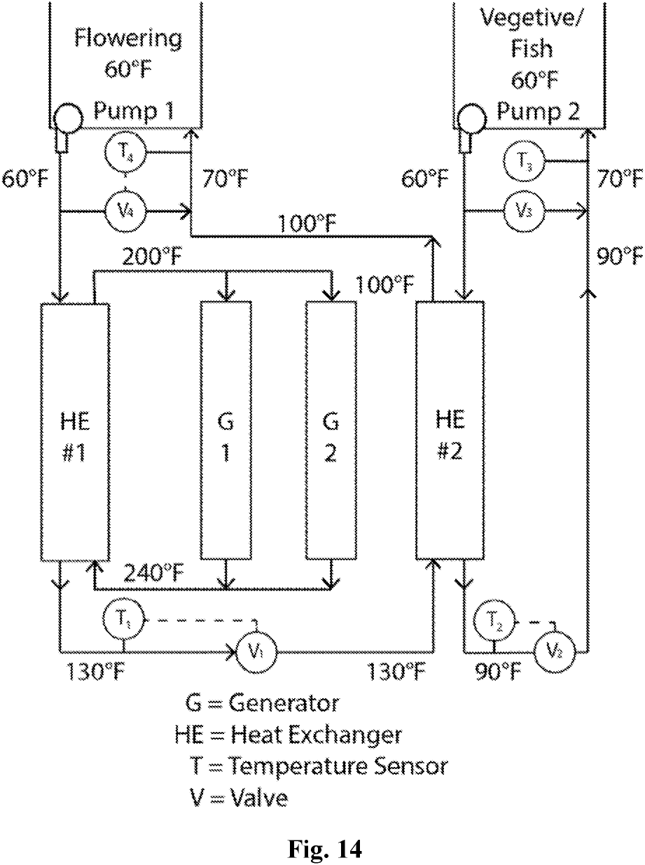

The closed loop water heat exchanger will transfer heat from the engine’s hot water to the cooler fish water without killing the beneficial bacteria, FIG. 14. The heat transfer capacity of Heat Exchanger #1 and #2 will be designed at 100% of both generators’ capacity, 70% Pump 1 capacity, 70% Pump 2 capacity, 50° F. vegetive/fish water and flowering water. Temperature sensors Ti will be linked to Vi to adjust loop water flow as the generator’s heat output decreases. In the same manner, temperature sensor T2 will be linked to V2 to adjust fish water flow. Temperature sensor T3 will be linked to V3 which mixes cooler fish water to adjust the temperature of returned fish water to 70° F. before being aerated back into the fish tank. Temperature sensor T4 will be linked to V4 to mix cooler flowering water.

Another improvement in this aquaponics process is the reclamation and 100% utilization of fish feces. The fish feces vacuumed off the bottom of the fish tank Level 1 will be fed to a centrifuge where it will be separated into water and solids, FIG. 15.

This centrifuge, unlike current industrial centrifuges, will not have to be shut down to be “cleaned out”. This centrifuge will extract 90% of the water from vacuumed water/feces solids. The extracted water will be returned to the Level 1 fish tank. The remaining 10% of the vacuumed water stream, composed primarily of fish feces, will be fed into a rotating ball mill. Processing this stream thru the ball mill will mineralize the fish feces completely and recover 100% of the remaining water. As the mill rotates the particle size of the feces will be reduced in size. The open end of the ball mill will be covered with filter cloth. A stream of 130° F. water will be sprayed on the outside of the filter cloth to keep it’s pores open. With the water in the ball mill being maintained at 130° F. nitrification bacteria will grow exponentially to mineralize the fish waste. The “clean” water from the ball mill will be directed Level 1 of the vegetive/fish stage.

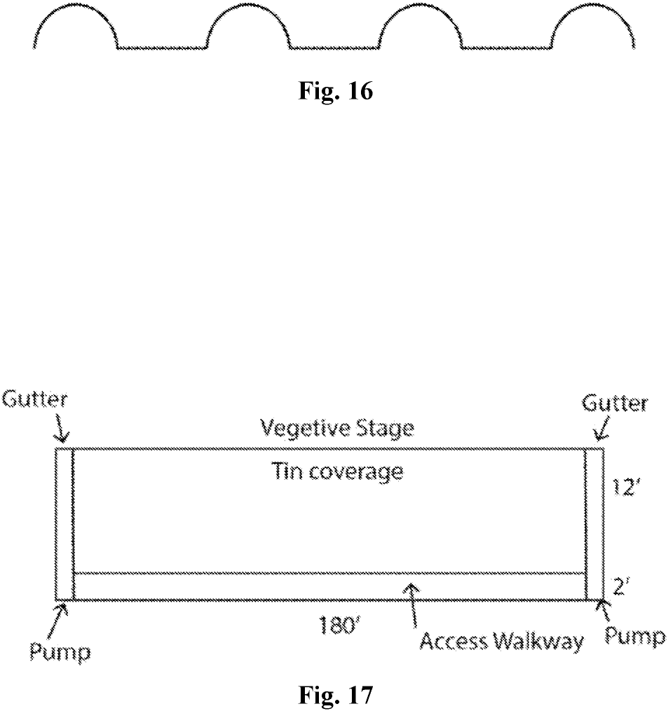

Progressive plant production can be achieved without the pools of water necessary for hydroponics or aquaponics. The pools can be replaced by installing runs of tin, 180 feet for vegetive and 300 feet for flowering. The tin is 3 feet wide with three valleys, FIG. 16.

Four runs will be needed to cover 12 ft, leaving 2 ft open for personnel access. All seams will be sealed with silicone. The tin will be raised 4 inches off the floor to accommodate a drain on each end to collect runoff water, FIG. 17. The runoff will be pumped to a collection tank. This water will be given to lawn service companies.

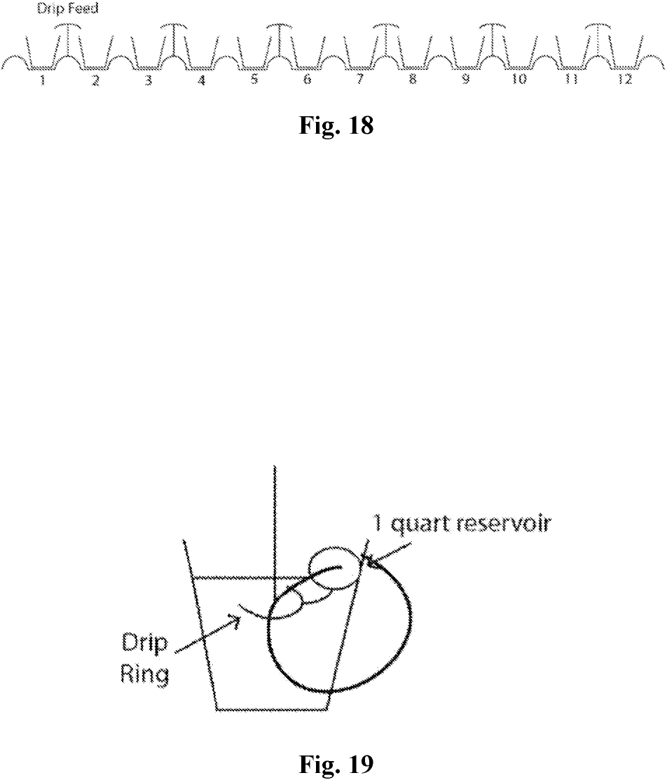

To provide watering in the vegetive stage a “run” of drips will be run atop the ridge at one-foot increments on every other ridge, FIG. 18. The drip feed will water a plant to the left and right. In each pot will be a reservoir capable of holding one quart of water as depicted in FIG. 19. The fill rate will be set to fill the 1-quart reservoir in 2 minutes. The water ring will evenly distribute water to the plant’s roots.

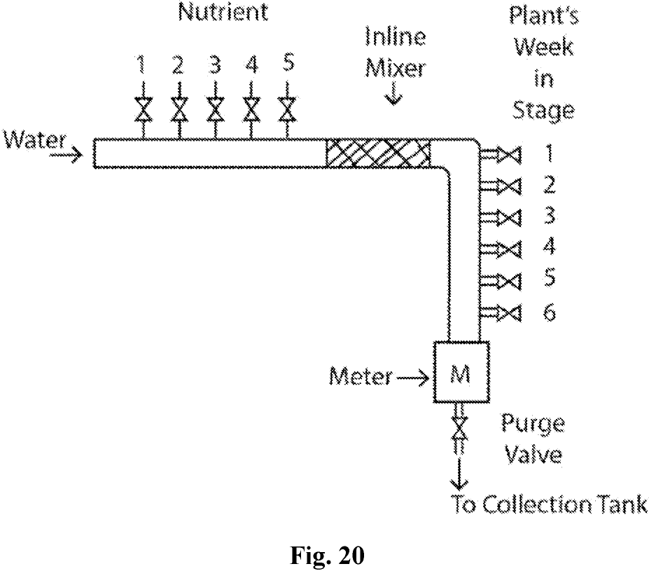

In the vegetive stage at any one time there will be six weeks of plantings in the stage. The Progressive Plant Production watering system will provide the water/nutrients specific for each week in the stage, FIG. 20. As needed the computer will feed water/nutrients to plants. At start-up the Meter will measure pH and conductivity. The mixed stream will be purged until specifications are met. The purge valve will be closed and the appropriate week’s plants fed.

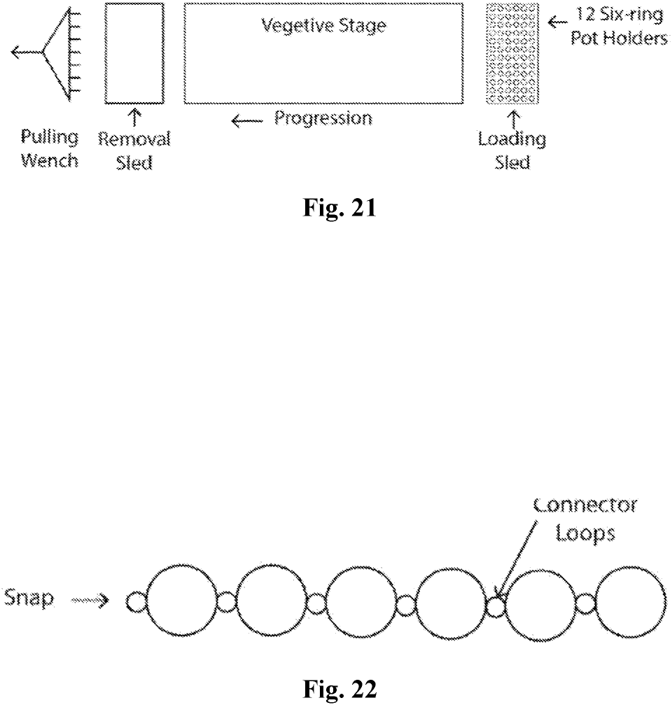

For loading the vegetive stage, the garage doors for the entrance and exit of the vegetive stage will be raised. A loading “sled” and removal sled will be put into place, FIG. 21. In this process 72 plants will be loaded, and 72 plants will be removed. Twelve six ring pots holders, FIG. 22, will be placed on the loading sled, as depicted in FIG. 21. The six ring potholders will be attached to their previous holder in the vegetive stage. The open rings will receive a potted plant. With a start signal from the loading end the winch will begin pulling until a six-ring pull has emerged from the vegetive stage onto the removal sled, FIG. 21.

Personnel will remove plants from the sled and trim plants. Plants will be sterilized with UV-C Light and microwaves, FIGS. 9 and 10.

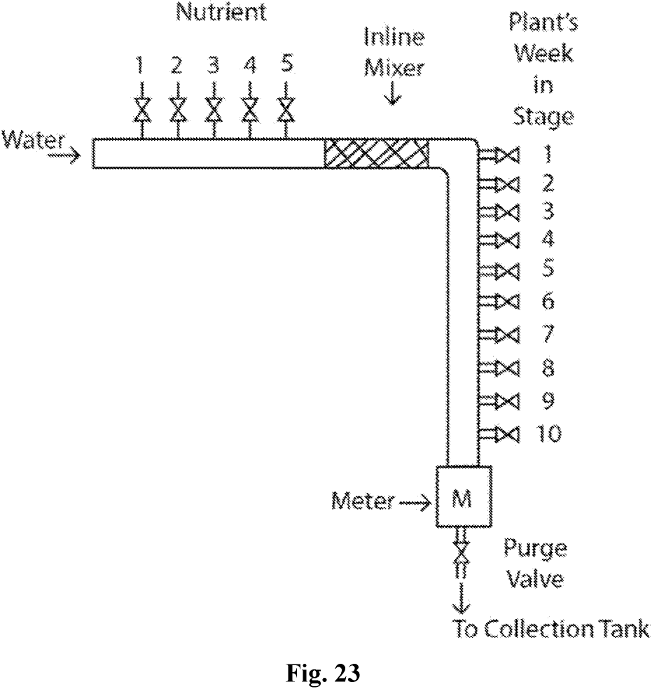

Watering in the flowering stage. In the flowering stage at any one time there will be ten weeks of plantings in the stage. The Progressive Plant Production system will provide water/nutrients specific for each week in the stage, FIG. 23. As before the computer will feed water/nutrients as needed to feed each week’s plants.

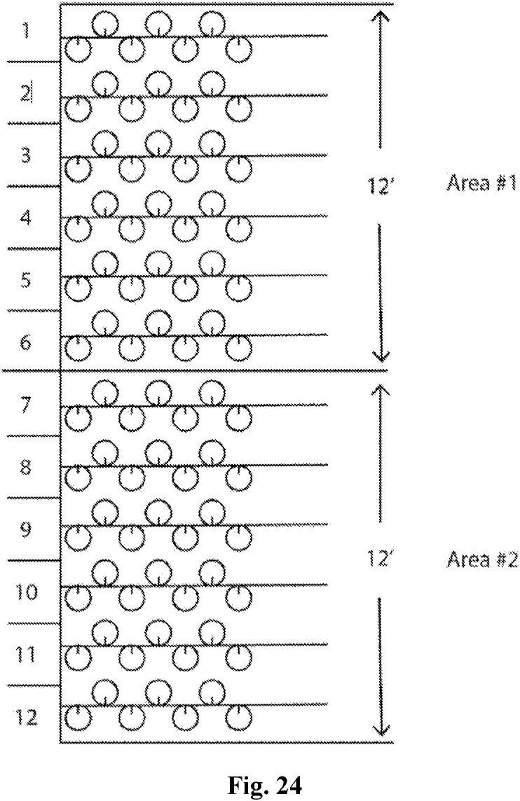

In the flowering stage a similar drip system to the vegetive stage will be installed on the ridge. However, because of spacing of plants, the first drip will be only to the right of the ridge. The next drip will be one foot down the ridge only to the left. This alternating right and left drip will be the continued protocol down the ridge. In the second space a pot will be on the left. This will continue for the 300-foot run. This spacing and drip arrangement will be in both flowering Areas #1 and #2, FIG. 24.

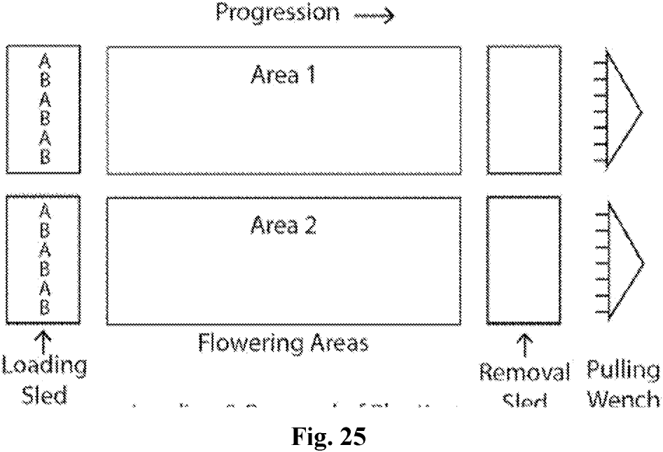

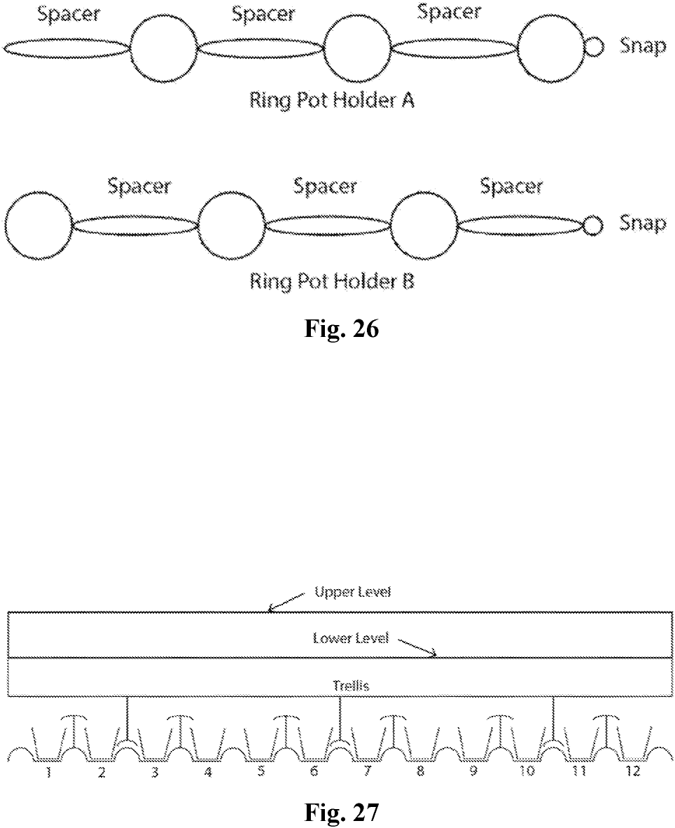

As with the vegetive stage, the flowering stage will have a loading and unloading sled, FIG. 25. To load the two sleds for flowering, two different ring pot holders will be used, Type A and Type B, FIG. 26.

Type A and Type B rings will be placed in the order on the loading sleds as previously depicted in FIG. 25. When ring placement is complete the entrance and exit garage doors to a flowering area will be opened. Each sled will be moved into position and the ring pulls snapped onto the rings inside the grow area. Plants will be loaded in the rings. The trellis, FIG. 27 will be guided between the plants and attached to the pull rings. The lower level of trellis mesh will be snapped into place followed by the upper level. With a start signal from the loading end the winch will begin pulling until a pull ring assembly has emerged. The ring assemblies will be detached, and all doors closed. The removed plants will be harvested and planted in the drying chamber.

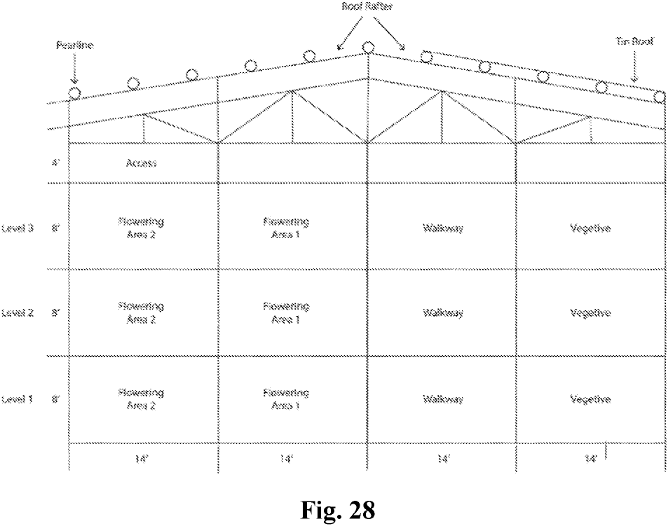

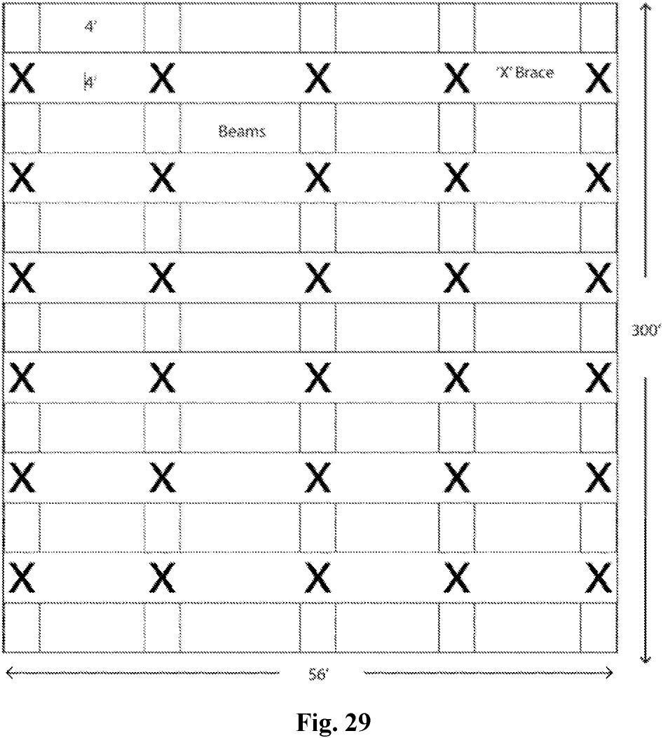

Progressive grow building structure. As depicted in FIG. 2, the width of the vegetive stage is 14 feet. As depicted in FIG. 11, the width of the flowering stages is 28 feet. The vegetive and twin flowering stages run counter parallel to each other, FIG. 12. The progressive plant process described in this patent is a two-level process. Given the industrial availability of pallet racking, the process can be expanded to three horizontal levels, FIG. 28. The building’s structural support will utilize the end pallet rack supports of the progressive plant process, FIG. 29. The integrity of the structure will be further enforced thru utilization of pallet rack beams to interlock the pallet rack ends. Also, “X” type bracing will laterally stabilize adjacent pallet rack ends, FIG. 29. The top of the pallet racks will support steel member root rafters, with pearling’s atop for the attachment of the tin roof, FIG. 28.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. A method of growing fish and marijuana in a single body of water, the method comprising:
Planting seeds;
Growing the seeds in a nursery until the plants are 8 inches tall;
Potting the plants into individual pots;
Placing the pots with the plants into a float;
Placing the float into a first bay in a vegetive stage tank with 58 bays and fish in corresponding baskets to be situated under the float with the potted plants;
Incubating the plants in the first bay and the fish in the corresponding fish basket for 7 days;
Moving the float and corresponding fish basket into the second bay;
Adding a second float with another round of potted plants and a second corresponding fish basket into the first bay;
Progressing the floats and corresponding fish baskets forward to the next bay and adding subsequent floats and corresponding fish baskets into the first bay each 7 days;
After 7 days in the 58^{th} bay, harvesting the fish and trimming the plants;
Transferring the trimmed plants into a flowering stage tank.

2. The method of claim 1, further comprising the step of exposing the plants to 18 hours of light per day during incubation.

3. The method of claim 1, further comprising:
Vacuuming the feces out of the tank;
Placing the feces in a centrifuge to separate water from solids;
Returning the water into the tank;
Using the feces as fertilizer for the plants.

4. An integrated marijuana and fish growing facility, the facility comprising:
A nursery where seeds will be planted and grown until each plant reaches approximately 8 inches in height;
A potting area where the 8 inch tall plants are individually potted and each pot is then placed into a float;
A vegetive stage growth tank where the float with the potted plants is placed above a corresponding fish basket in a first bay in the tank, the tank having 58 bays;
A fish harvesting area wherein after the fish basket has progressed through the 58^{th} bay, the fish will be harvested for sale;
A plant trimming area whereing after progressing through the 58^{th} bay in the vegetive stage growth tank, the plants will be trimmed and transferred to the flowering stage; and
A flowering stage growth tank where the float is placed after trimming.
